(19) United States
(12) Patent Application Publication
(10) Pub. No.: US 2005/0156890 A1
(43) Pub. Date: Jul. 21, 2005

(54) Pointing device having a loop-like touch pad for implementing a scrolling function

(75) Inventor: Markus Wierzoch, Taipei Hsien (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/023,488

(22) Filed: Dec. 29, 2004

(30) Foreign Application Priority Data
Dec. 31, 2003 (TW) 92137627

(51) Int. Cl. G09G 5/08

(52) U.S. Cl. 345/163

(57) ABSTRACT

A pointing device connected to a computer system is used to control the movement of a cursor in a screen of the computer system. A loop-like touch pad is disposed on the top surface of the pointing device. When a user's finger touches and rotates clockwise/counterclockwise on the loop-like touch pad images in the screen can be continuously scrolled downward/upward.

### FIELD OF THE INVENTION

The present invention relates to a pointing device and, more specifically, to a computer mouse having a loop-like touch pad which implements a scrolling function for computer images in a computer screen.

### BACKGROUND OF THE INVENTION

With unceasing advancement and development of electronic technology, multi-media computers with high-quality picture and sound are preferred and broadly used by consumers so as to accelerate popularization of computers. Furthermore, increasing consumption of computer-related products prompts flourishing development in related industries.

In order that the consumers can operate the computer conveniently and quickly, the computer may usually be equipped with a computer mouse as a peripheral device in addition to a keyboard for commanding and inputting. With the computer mouse, the consumers can directly move a cursor on the screen to implement a pointing operation.

A trackball is mounted at the bottom of a typical mouse. When the mouse is grasped by a user to move on the top of a desk, the trackball at the bottom of the mouse rolls to move the cursor in the screen. Once the cursor is moved to a location desired for pointing, the left and right buttons on the mouse can be depressed to open files or execute relevant programs and applications. Furthermore, a scrollbar roller is installed over the present mouse to facilitate the up and down scrolling of the images in the screen by the mouse. The user can roll the roller to scroll the images in the screen. Referring to FIG. 1, the user presses a scrollbar roller 11 of a mouse 1 with the front end of his finger and rolls the roller 11 forward or backward to control the up and down scrolling of the image in the screen.

The design of the scrollbar roller 11 is still inconvenient for use. For instance, when the user wants to scroll the images in the screen downward, he presses the front edge of the scrollbar roller 11 with his finger and rolls the roller 11 backward. However, once the roller 11 is rolled to the rear edge, the user needs to lift his finger up to the front edge of the scrollbar roller 11 to depress the front edge of the roller 11 again and then to roll the roller 11 backward. As shown in FIG. 1, the finger of the user needs to repeatedly move along the direction of the arrow 12 to rotate the roller. Under such circumstance, the image in the screen cannot be smoothly and continuously scrolled up or down. Moreover, the user wastes much energy in the repeated frontward movements of his finger and this violates the principle of ergonomics.

Therefore, it is desired to design a novel computer mouse to overcome the drawback of the conventional roller being unable to continuously scroll the images in the screen and for the user to conveniently control the scrolling of the images in the screen with less energy.

### SUMMARY OF THE INVENTION

The objective of the present invention is to provide a pointing device having a loop-like touch pad. Depressing and rotating on the loop-like touch pad can scroll images in a screen.

A pointing device connected to a computer system is disclosed in this invention to control the movement of the cursor in the screen of the computer system. The pointing device comprises a loop-like touch pad disposed near the front side of the top surface of the mouse for controlling the up and down scrolling of images in the screen. When a user touches around the center of the loop-like touch pad and clockwise/counterclockwise rotates on the loop-like touch pad, the images in the screen are continuously scrolled downward/upward. The pointing device may be a computer mouse or other input apparatuses. Moreover, the pointing device may include some control element, as a circular button disposed at the central location of the loop-like touch pad and two control buttons respectively disposed at the left and right sides of the loop-like touch pad for opening files and executing programs and applications of the computer system.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic perspective diagram showing the scrolling operation of a conventional computer mouse with a roller;

FIGS. 2A, 2B and 2C are respectively a top view, a side view and a front view of a computer mouse having a loop-like touch pad in accordance with this invention; and

FIG. 3 shows the operation of the computer mouse having a loop-like touch pad in accordance with this invention.

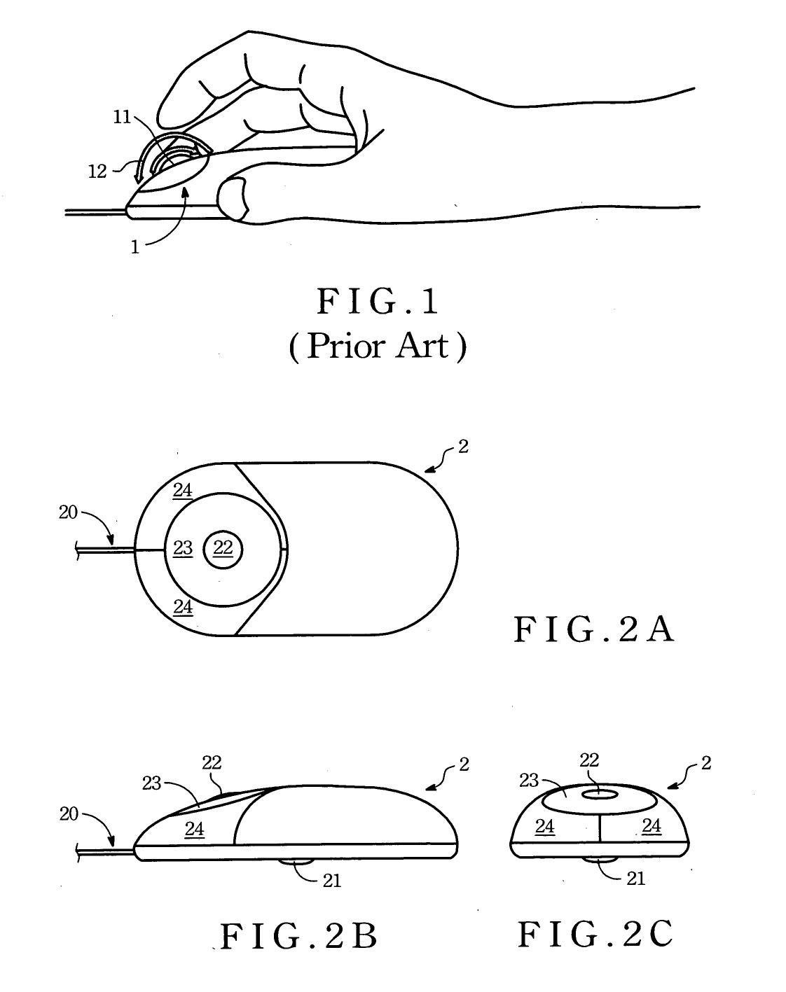

### DETAILED DESCRIPTION OF THE PREFERRED EMBODIMENT

An embodiment of the invention provides a computer mouse. Refer to FIGS. 2A, 2B and 2C which are respectively a top view, a side view and a front view of a computer mouse having a loop-like touch pad provided in this invention. The computer mouse 2 is applied in a computer system to control the movement of the cursor in the screen of the computer system. Generally, a trackball 21 is assembled at the bottom surface of the computer mouse 2. When the computer mouse 2 is grasped by a user to move on a contact surface such as the top of a desk or on a mouse pad, the trackball 21 mounted at the bottom of the computer mouse 2 rolls to move the cursor in the screen. The front end of the computer mouse 2 has a cable 20 extending outward to connect with the computer system.

Several buttons are disposed on the top surface of the computer mouse 2. Once the user moves the cursor to a location desired for pointing, these buttons on the mouse can be depressed to open files or execute relevant programs and applications. Preferably, these buttons include a circular button 22, a loop-like touch pad 23 and two control buttons 24. As shown in the FIGS. 2A, 2B and 2C, the circular button 22 is disposed at the central location near the front side of the top surface of the computer mouse 2 and the loop-like touch pad 23 is disposed around the circular button 22. The two control buttons 24 are respectively disposed at the left and right sides of the loop-like touch pad 23.

The loop-like touch pad 23 disposed around the circular button 22 is mainly used to control the up and down scrolling of images in the screen. When the finger of the user touches around the center of the loop-like touch pad 23 and rotates on the loop-like touch pad 23 clockwise or counterclockwise, the images in the screen may be continuously scrolled downward or upward. The two control buttons 24 respectively disposed at the left and right sides of the loop-like touch pad 23 and the circular button 22 disposed at the center of the loop-like touch pad 23 may be set with a respective function to select, drag or open files and executes programs and applications of the computer system.

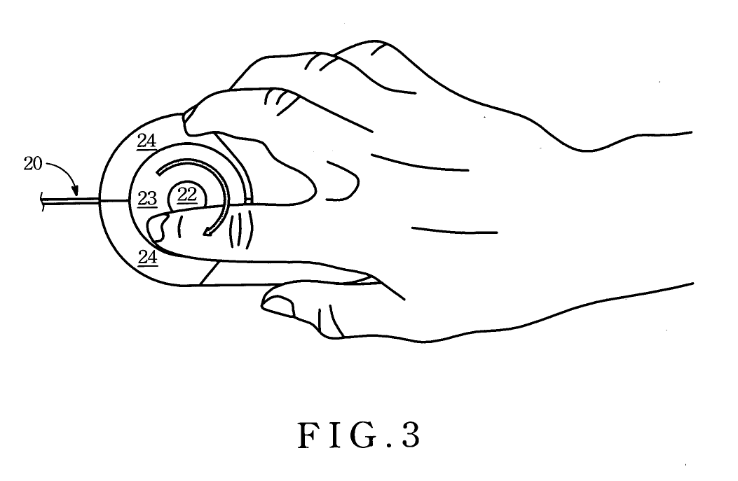

Refer to FIG. 3, showing that the user operates the computer mouse 2. The user holds the computer mouse 2 with his right hand to move the computer mouse 2 so as to control the location of the cursor in the screen. As shown in FIG. 3, the finger of the user touches around the center of the loop-like touch pad 23 clockwise to scroll the image in the screen. When the user's finger touches and rotates on the loop-like touch pad 23 continuously, the image in the screen can be scrolled without interruption. Namely, when the loop-like touch pad 23 receives a clockwise/counterclockwise touch around the center of the loop-like touch pad, images in the screen are continuously scrolled downward/upward. Furthermore, the loop-like touch pad 23 may be rotated by the user continuously, the image in the screen can be scrolled without interruption. The scrolling speed of the image in the screen changes along with the change of the rotating speed. Hence, the user can freely control the scrolling speed of the image in the screen to search or browse.

It is noted that in above embodiment, the image in the screen is scrolled when the user using his or her finger and dragging it across the surface of the loop-like touch pad. However, in another embodiment, the loop-like touch pad can be fabricated to be rotatable, and the image in the screen can be scrolled when the user's finger rotate the loop-like touch pad clockwise/counterclockwise by the clockwise/counterclockwise touch continuously.

The computer mouse having the loop-like touch pad in this invention has considerable advantages. Firstly, comparing with the conventional mouse having the roller to scroll, the user need not repeatedly lift his finger up to rotate the roller when employing the loop-like touch pad to scroll. The user merely rotates the loop-like touch pad continuously. Obviously, such a design of the computer mouse can help the user easily control the scrolling of the image in the screen without wasting energy. Moreover, as long as the user rotates the loop-like touch pad continuously, the image in the screen can be scrolled without interruption. This facilitates searching or browsing information promptly.

As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

1. A pointing device connected to a computer system for controlling the movement of a cursor in a screen of the computer system, comprising a loop-like touch pad disposed on the top surface of the pointing device, wherein when the loop-like touch pad receive a clockwise/counterclockwise touch around the center of the loop-like touch pad, images in the screen are continuously scrolled downward/upward.

2. The pointing device of claim 1, wherein the loop like touch pad clockwise/counterclockwise rotated by the clockwise/counterclockwise touch.

3. The pointing device of claim 1, further comprising a circular button disposed at the center of the loop-like touch pad on the top surface of the pointing device.

4. The pointing device of claim 1, further comprising two control buttons respectively disposed at the left and right sides of the loop-like touch pad on the top surface of the pointing device.

5. The pointing device of claim 1, further comprising a trackball assembled at the bottom surface of the pointing device, wherein the trackball roll of the pointing device grasped by a user moves on a contact surface, the cursor moves in the screen by the rolling of the trackball.

6. The pointing device of claim 1, further comprising a cable extending outward from the pointing device to connect with the computer system.

7. A pointing device connected to a computer system for controlling the movement of a cursor in a screen of the computer system, comprising:
a circular button, disposed at the central location near the front side of the top surface of the pointing device;
a loop-like touch pad, disposed around the circular button for controlling the up and down scrolling of images in the screen, wherein when the loop-like touch pad receive a clockwise/counterclockwise touch around the center of the loop-like touch pad, the images in the screen are continuously scrolled downward/upward; and
two control buttons, respectively disposed at the left and right sides of the loop-like touch pad for opening files and executing programs and applications of the computer system.

8. The pointing device of claim 7, further comprising a trackball assembled at the bottom surface of the pointing device, wherein the trackball roll of the pointing device grasped by a user moves on a contact surface, the cursor moves in the screen by the rolling of the trackball.

9. The pointing device of claim 7, further comprising a cable extending outward from the pointing device to connect with the computer system.

10. A pointing device for controlling the movement of a cursor in a screen having images, comprising:
a cursor control element, disposed on the top surface of the pointing device; and
a loop-like touch pad, disposed on the top surface of the pointing device and around the cursor control element to scroll the images in the screen.

11. The pointing device of claim 10, wherein the loop like touch pad clockwise/counterclockwise rotated by the clockwise/counterclockwise touch.

12. The pointing device of claim 10, further comprising two control buttons respectively disposed at the left and right sides of the loop-like touch pad on the top surface of the pointing device.

13. The pointing device of claim 10, further comprising a trackball assembled at the bottom surface of the pointing device, wherein the trackball roll of the pointing device grasped by a user moves on a contact surface, the cursor moves in the screen by the rolling of the trackball.

14. The pointing device of claim 10, further comprising a cable extending outward from the pointing device to connect with the computer system.
